(19) United States
(12) Patent Application Publication
(10) Pub. No.: US 2006/0097856 A1
(43) Pub. Date: May 11, 2006

(54) Warning lamp device for bicycle

(76) Inventor: Rong-Zhou Cao, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/983,319

(22) Filed: Nov. 8, 2004

(51) Int. Cl. B62J 6/00

(52) U.S. Cl. 340/432

(57) ABSTRACT

A warning lamp device for a bicycle includes a solar collector including a control circuit having a light sensitive control switch, and a vibration control switch. Thus, the light sensitive control switch and the vibration control switch of the control circuit of the solar collector are controlled in a synchronous manner, so that the warning lamp device is operated only when the light sensitive brightness of the light sensitive control switch is smaller than a predetermined value and when the bicycle is moving to provide a viewing and warning effect, thereby saving the electrical energy.

### BACKGROUND OF THE INVENTION

1. Field of the Invention

The present invention relates to a solar warning lamp device, and more particularly to a solar warning lamp device for a bicycle.

2. Description of the Related Art

A conventional warning lamp device for a bicycle comprises a warning lamp mounted on the rear position of a bicycle, and a control circuit connected to the warning lamp by electric wires. However, the warning lamp is lighted and distinguished by a manual work, thereby causing inconvenience to a rider in operating the warning lamp. In addition, the conventional warning lamp device needs to provide electric wires which are exposed outward from the bicycle, thereby affecting the outer appearance of the bicycle.

### SUMMARY OF THE INVENTION

In accordance with the present invention, there is provided a warning lamp device, comprising:

a solar collector including a control circuit including a light sensitive control switch, and a vibration control switch;

wherein the light sensitive control switch and the vibration control switch of the control circuit of the solar collector are controlled in a synchronous manner.

The primary objective of the present invention is to provide a solar warning lamp device for a bicycle.

Another objective of the present invention is to provide a warning lamp device, wherein the light sensitive control switch and the vibration control switch of the control circuit of the solar collector are controlled in a synchronous manner, so that the warning lamp device is operated only when the light sensitive brightness of the light sensitive control switch is smaller than a predetermined value and when the bicycle is moving to provide a viewing and warning effect, thereby saving the electrical energy.

A further objective of the present invention is to provide a warning lamp device, wherein the warning lamp device is operated automatically when the detected brightness is smaller and when the bicycle is moving, without needing the manual work, thereby facilitating a rider employing the warning lamp device.

A further objective of the present invention is to provide a warning lamp device, wherein the solar collector is waterproof so as to protect the control circuit and the batteries, thereby enhancing the lifetime of the warning lamp device.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a warning lamp device for a bicycle in accordance with the preferred embodiment of the present invention;

FIG. 2 is a plan assembly view of the warning lamp device for a bicycle as shown in FIG. 1;

FIG. 3 is a plan assembly view of the warning lamp device for a bicycle as shown in FIG. 1;

FIG. 4 is a plan assembly view of a warning lamp device for a bicycle in accordance with another embodiment of the present invention;

FIG. 5 is a plan assembly view of a warning lamp device for a bicycle in accordance with another embodiment of the present invention;

FIG. 6 is a circuit diagram of the warning lamp device for a bicycle as shown in FIG. 1;

FIG. 6A is a circuit diagram of the warning lamp device for a bicycle as shown in FIG. 1;

FIG. 7 is a circuit diagram of the warning lamp device for a bicycle as shown in FIG. 1; and

FIG. 8 is a circuit diagram of the warning lamp device for a bicycle as shown in FIG. 1.

### DETAILED DESCRIPTION OF THE INVENTION

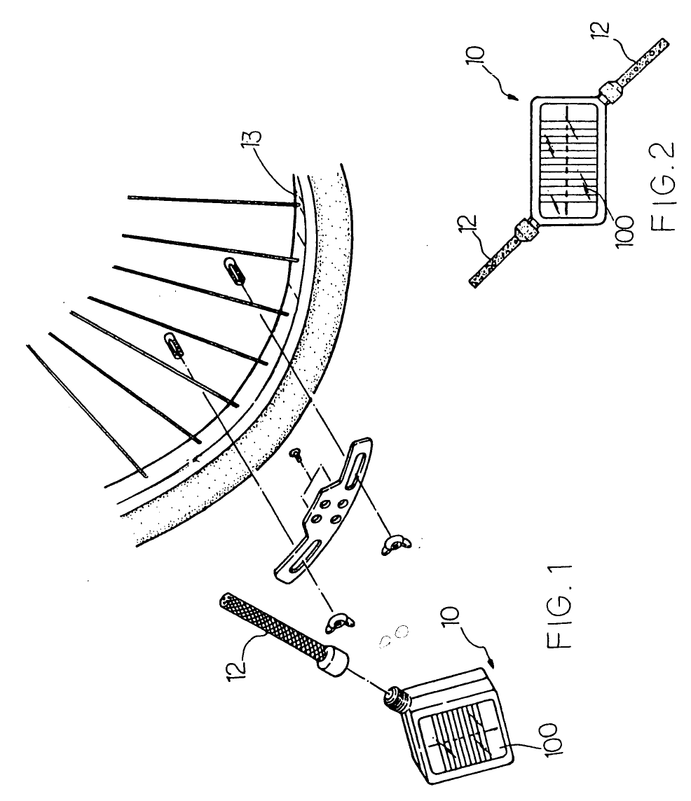

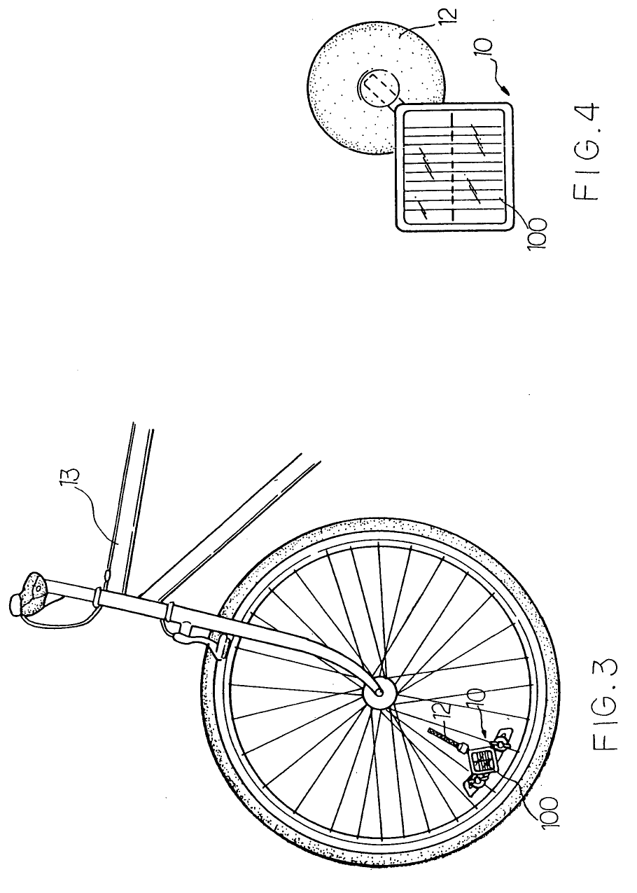

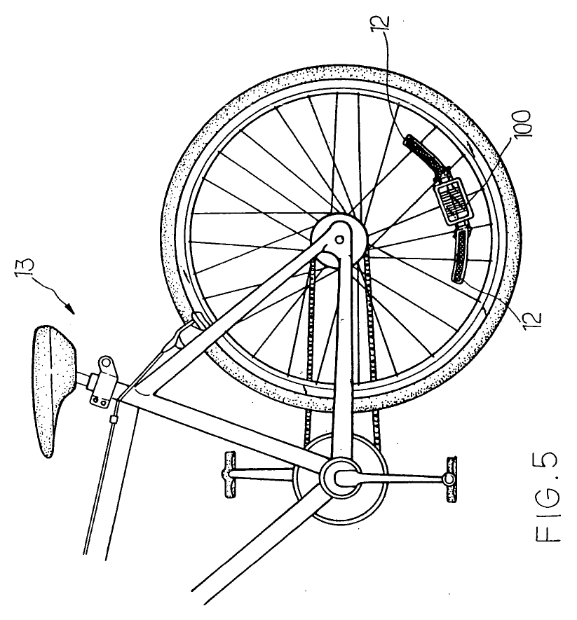

Referring to the drawings and initially to FIGS. 1-5, a warning lamp device for a bicycle in accordance with the preferred embodiment of the present invention comprises a solar collector 10, a set of batteries 11, and at least one photo-conductive unit 12.

The solar collector 10 includes a solar panel 100, and a control circuit 101.

The solar panel 100 of the solar collector 10 is used for receiving and converting the solar energy into an electrical energy.

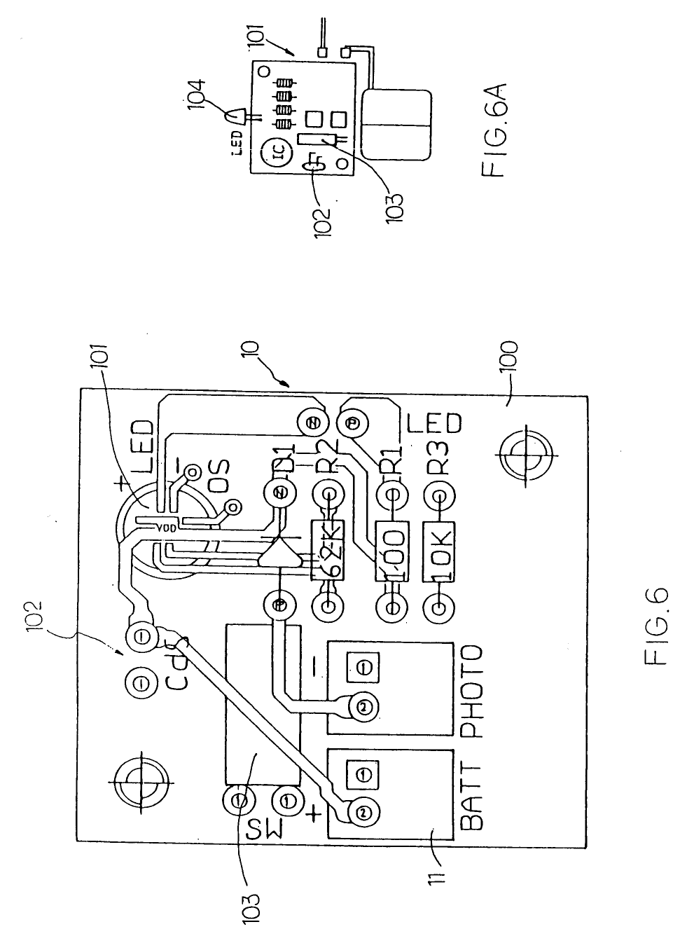

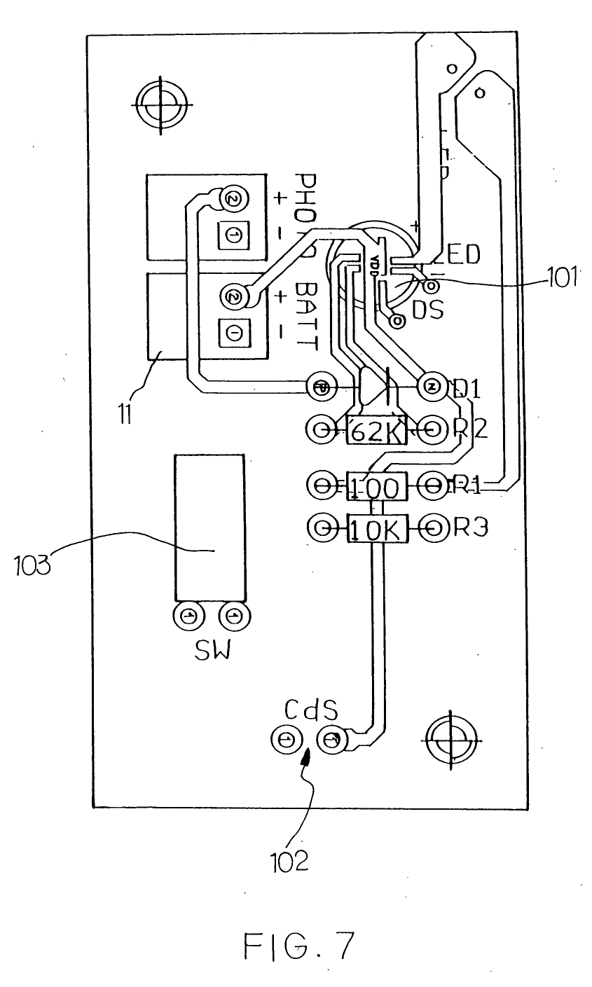

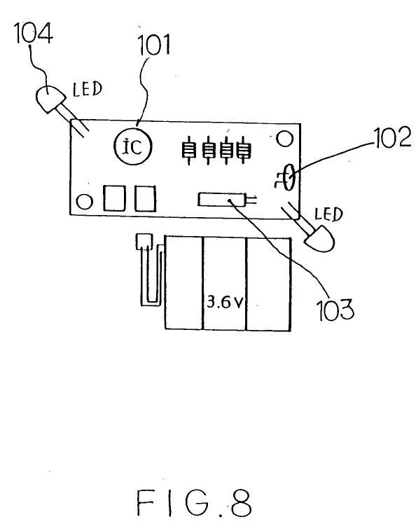

As shown in FIGS. 6-8, the control circuit 101 of the solar collector 10 is an integrated circuit (IC) and includes a light sensitive control switch 102 for detecting brightness of the ambient environment, a vibration control switch 103 for detecting vibration of the bicycle, and a plurality of light emitting members 104, such as light emitting diodes (LED). Preferably, the light sensitive control switch 102 and the vibration control switch 103 of the control circuit 101 of the solar collector 10 are controlled in a synchronous manner, so that the warning lamp device is operated only when the light sensitive brightness of the light sensitive control switch 102 is smaller than a predetermined value and when the bicycle is moving.

The batteries 11 are mounted in the solar collector 10 and used to store the electrical energy from the solar panel 100 of the solar collector 10 and to supply the electrical energy to the light emitting members 104. Preferably, the time ratio of charging and discharging of the batteries 11 is greater than one third (⅓), so that when the solar panel 100 of the solar collector 10 absorbs the solar energy during one hour, the batteries 11 supply the electrical energy to the light emitting members 104 during three hours.

The photo-conductive unit 12 is mounted on the solar collector 10. The photo-conductive unit 12 is a lamp shade or a photo-conductive interface made of a material having highly photo-conductive capacity. Preferably, the photo-conductive unit 12 is made of acrylic material having a special photo-conductive reflective face so as to amplify a weaker light source into a stronger light to provide a better viewing and warning effect.

In practice, as shown in FIGS. 1-5, the solar collector 10 is mounted on any position of the bicycle 13, so that the warning lamp device is available for all kinds of bicycles.

In such a manner, the light sensitive control switch 102 and the vibration control switch 103 of the control circuit 101 of the solar collector 10 are controlled in a synchronous manner, so that the warning lamp device is operated only when the light sensitive brightness of the light sensitive control switch 102 is smaller than a predetermined value and when the bicycle is moving, so as to provide a better viewing and warning effect.

Accordingly, the light sensitive control switch 102 and the vibration control switch 103 of the control circuit 101 of the solar collector 10 are controlled in a synchronous manner, so that the warning lamp device is operated only when the light sensitive brightness of the light sensitive control switch 102 is smaller than a predetermined value and when the bicycle is moving to provide a viewing and warning effect, thereby saving the electrical energy. In addition, the warning lamp device is operated automatically when the detected brightness is smaller and when the bicycle is moving, without needing the manual work, thereby facilitating a rider employing the warning lamp device. Further, the solar collector 10 is waterproof so as to protect the control circuit 101 and the batteries 11, thereby enhancing the lifetime of the warning lamp device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A warning lamp device, comprising:
a solar collector including a control circuit including a light sensitive control switch, and a vibration control switch;
wherein the light sensitive control switch and the vibration control switch of the control circuit of the solar collector are controlled in a synchronous manner.

2. The warning lamp device in accordance with claim 1, wherein the warning lamp device is operated only when a light sensitive brightness of the light sensitive control switch is smaller than a predetermined value and when the bicycle is moving.

3. The warning lamp device in accordance with claim 1, wherein the control circuit of the solar collector is an integrated circuit (IC).

4. The warning lamp device in accordance with claim 1, wherein the light sensitive control switch is used for detecting brightness of the ambient environment.

5. The warning lamp device in accordance with claim 1, wherein the vibration control switch is used for detecting vibration of the bicycle.

6. The warning lamp device in accordance with claim 1, wherein the solar collector further includes a solar panel for receiving and converting the solar energy into an electrical energy.

7. The warning lamp device in accordance with claim 1, wherein the control circuit further includes a plurality of light emitting members.

8. The warning lamp device in accordance with claim 7, further comprising a set of batteries mounted in the solar collector to store an electrical energy converted from a solar energy of the solar panel of the solar collector and to supply the electrical energy to the light emitting members.

9. The warning lamp device in accordance with claim 8, wherein a time ratio of charging and discharging of the batteries is greater than one third (⅓).

10. The warning lamp device in accordance with claim 1, further comprising at least one photo-conductive unit mounted on the solar collector.

11. The warning lamp device in accordance with claim 10, wherein the photo-conductive unit is a lamp shade.

12. The warning lamp device in accordance with claim 10, wherein the photo-conductive unit is a photo-conductive interface.

13. The warning lamp device in accordance with claim 10, wherein the photo-conductive unit is made of acrylic material having a photo-conductive reflective face.

14. The warning lamp device in accordance with claim 1, wherein the solar collector is mounted on any position of a bicycle.

15. The warning lamp device in accordance with claim 1, wherein the warning lamp device is operated automatically when the detected brightness is smaller and when the bicycle is moving, without needing a manual work.

16. The warning lamp device in accordance with claim 1, wherein the solar collector is waterproof.
